(19) United States
(12) Patent Application Publication
(10) Pub. No.: US 2005/0059419 A1
(43) Pub. Date: Mar. 17, 2005

(54) Method and apparatus for providing smart replies to a dispatch call

(76) Inventor: Michael A. Sharo, Lake Zurich, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/659,993

(22) Filed: Sep. 11, 2003

(51) Int. Cl. H04Q 7/20

(52) U.S. Cl. 455/521

(57) ABSTRACT

A method for providing replies to a dispatch call includes the step of selecting if the response is going to be automatic or manual (110). If automatic response is selected, the voice response that is to be automatically transmitted upon receiving a dispatch call is selected (118). The method also allows for a radio user to record new voice responses (116) which can then be placed in either an automatic or manual response mode. A radio which can provide for responses to a dispatch call includes memory (418) for storing the preprogrammed voice messages that will be used as replies to the dispatch call.

### TECHNICAL FIELD

This invention relates in general to the field of radio communications and more specifically to a method and apparatus for providing smart replies to dispatch calls.

### BACKGROUND

In a radio communication system such as the Motorola, Inc. iDEN® (Integrated Digital Enhanced Network) radio communication system, traditional Push-To-Talk (PTT), half-duplex, analog radio technology is combined with full-duplex digital cellular technology. This PTT technology is also referred to as dispatch calling (dispatch calling is also known as Direct Connect™TM) and it splits a single carrier into multiple channels, with one of the channels being used for a dispatch call.

Dispatch calls allow for one user to immediately connect with another user or a group of users (e.g., referred to as private dispatch or group dispatch calls) and have a private conversation with the press of the PTT switch. With dispatch communications, each of the users involved in a dispatch call has to depress the PTT switch on his/her radio to transmit a message to the other dispatch call participants given the half-duplex nature of the communications.

One problem experienced today is that in certain situations, a radio user may not be able to respond to a dispatch call (e.g., currently in a meeting, etc.) or may want to avoid the dispatch call altogether, but yet may want to acknowledge the call and/or explain the reason to the dispatch caller (originating radio) why he/she cannot respond to the dispatch call. When a dispatch call is received, the radio user hears the voice of the caller. Currently, the receiving radio user has no way of letting the originating radio know he/she cannot get to the call. Some radio users have attempted to resolve this problem by the receiving radio user simply pressing and releasing the PTT switch without speaking, which causes a “chirp” to be heard at the originating radio. The chirp, without any voice message, signifies that the radio user has received the dispatch call but cannot respond. Although useful, this “chirp back” technique is limited in use, and does not provide any information to the originating radio as to the reason why the receiving radio cannot respond to the call. A need thus exists in the art for a method and apparatus which can alleviate some of the problems previously mentioned regarding the current lack of response capability when a dispatch call cannot be answered.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows a flowchart highlighting the process of enabling a smart reply mode in accordance with an embodiment of the invention.

FIG. 2 shows a flowchart highlighting the process of disabling the smart reply mode in accordance with an embodiment of the invention.

FIG. 3 shows a flowchart highlighting the process of responding to a call alert or dispatch call using smart replies in accordance with an embodiment of the invention.

FIG. 4 shows a block diagram of a radio in accordance with an embodiment of the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

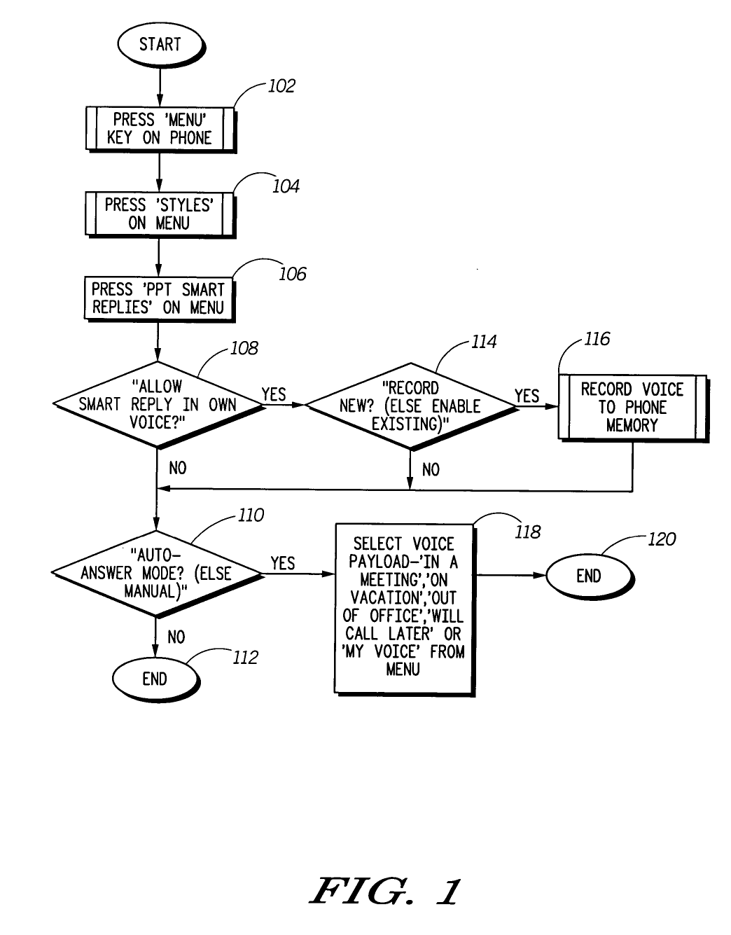

Referring now to FIG. 1, there is shown a flowchart highlighting the steps of how to enable “smart replies” to dispatch calls in accordance with an embodiment of the invention. Smart replies are replies that can be provided by a radio in response to receiving a dispatch call such as an individual or group dispatch call or call alert. In accordance with an embodiment of the present invention, the radio user can program voice replies that can be stored in the radio's memory and be transmitted back to the originating radio. These replies can include voice messages such as “In a meeting”, “On vacation”, “Out of the Office”, “Will call later”, etc. Instead of programming the radio users own voice, some preprogrammed voice responses can already be preprogrammed into the radio during the manufacture of the radio in an alternative embodiment.

In step 102, the “menu” key on a radio capable of receiving/transmitting dispatch calls (see for example the radio in FIG. 4) is pressed. In step 104, in the next layer of the menu (user interface) the “styles” menu button is pressed. The “styles” menu layer includes items that the radio user can use to configure his/her radio to suit the needs of the radio user. In step 106, if the radio user presses the “PTT Smart Replies” menu item, the routine moves to step 108, were the radio user can decide if he wants the smart replies in his/her own voice. If the user affirmed step 108, in step 114, the menu asks the user if he/she wants to record a new smart reply. If a smart reply needs to be recorded into memory, it is recorded in step 116. As part of step 116, the user can also program a name for the smart reply, for example, if the user records, “I am on vacation until Thursday”, the user can label this smart reply accordingly.

In step 110, the radio user can select if he/she wants the radio to automatically answer with a smart reply anytime the radio receives a dispatch call (e.g., individual dispatch call, call alert, etc.). If the auto-answer is selected, in step 118, the radio user selects the smart reply he/she wants to use as the smart reply, and in step 120 the routine is exited. If in step 110, the radio user does not want the radio to automatically respond to a dispatch call or call alert, the radio user does not select the auto-answer in step 110 and the routine exits in step 112. Note that even if the radio user does not select the auto-answer mode, the radio user can still manually provide a smart reply to a dispatch call as will be discussed later.

Although a specific method of selecting the smart replies of the present invention has been discussed in reference to FIG. 1, it should be noted that there are many ways to activate smart replies or program replies to be used to respond to dispatch calls in accordance with the present invention. Even radios (phones) that do not have a display can take advantage of the present invention, by having at least one user control such as a button (switch) that can activate a preprogrammed response that can be transmitted either automatically upon receiving a dispatch call or manually.

In order to disable a smart reply mode that was previously selected in FIG. 2 there is shown the process of how the smart reply mode is disabled in accordance with one embodiment of the invention. In step 202, the radio user presses the Menu key on the phone, next the “Styles” menu item is selected in step 204. Finally, in step 206, the “Off” menu item is selected and the routine is exited in step 208. In a radio with only one user control or switch such as mentioned above, the user may simply need to press the switch one more time to deactivate the smart reply feature of the present invention.

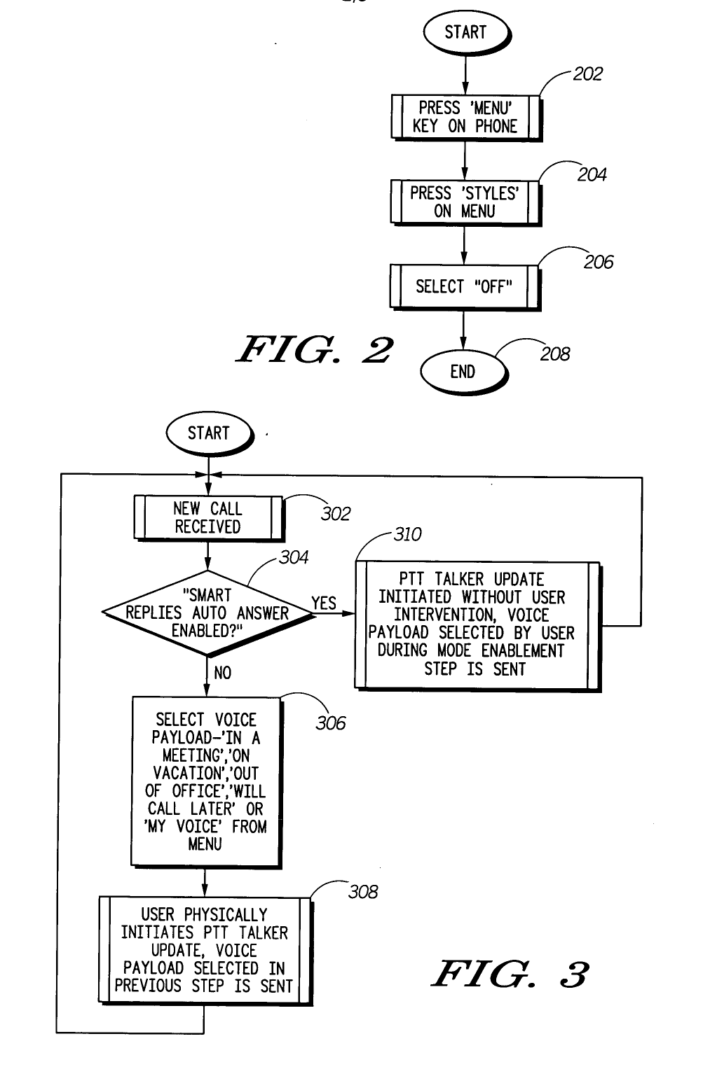

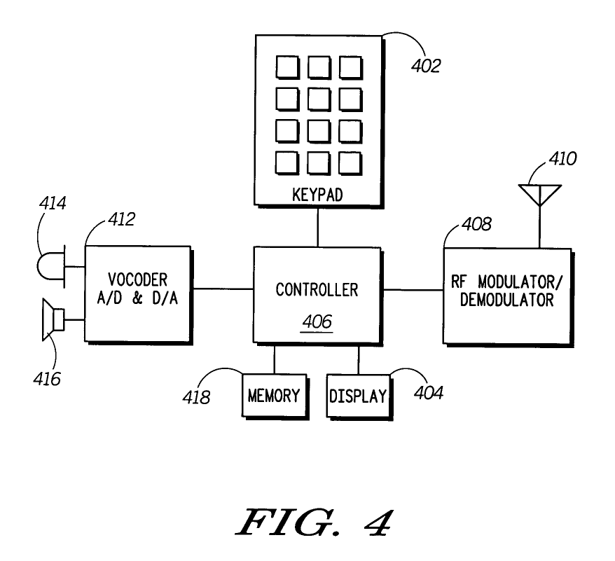

In FIG. 3, the process on how a radio responds to a dispatch call is shown. In step 302 a new dispatch call is received, in step 304 the radio determines if the smart replies auto answer mode was enabled by the radio user. If the auto-answer mode was selected, the selected smart reply voice message is automatically transmitted to the originating radio in step 310. This voice message for example, can alert the originator that the destination radio user is in a meeting and cannot respond to the call. The automatic smart reply transmitted in step 310 in one embodiment of the invention is a private call with both parties receiving the familiar “chirp” of a dispatch call.

If in step 304 it is determined that the auto response mode is not selected, in step 306, the radio user can manually select from amongst the different pre-stored smart replies, preferably, all of the smart replies have been labeled and the radio user simply has to run down a menu list and select the smart reply he/she wants to be transmitted. In step 308, the user physically initiates a smart reply response by pressing the PTT button on the radio, which causes the previously selected smart reply to be transmitted. In step 306, the user can also select a “no smart reply” menu item in case the radio user does not want any smart reply to be transmitted.

Any automatic smart replies transmitted in step 310 in one embodiment of the invention are reflected in the “recent calls” menu list of the radio and are preferably denoted with a visible indication that a smart reply was transmitted. This will allow the radio user to scroll the “recent calls” list and get back to those callers that got sent a smart reply.

In FIG. 4, there is shown a block diagram of a radio communication device in accordance with an embodiment of the invention. The radio communication device in this embodiment is a radio telephone that can support dispatch calls and cellular calls. The radio communication device includes a controller 406 such as a microprocessor and/or digital signal processor that controls the overall function and operation of the communication device. User controls such as keypad 402 and display 404 are coupled to the controller 406 and allow for user interface with the communication device. The keypad 402 and display 404 are used to select or program a new smart reply as previously mentioned. A PTT switch is also part of the user controls and is used to activate a dispatch call. Memory 418 can comprise both volatile and nonvolatile memory including but not limited to Random Access Memory (RAM), Flash memory, Read-Only Memory (ROM), etc. The stored smart replies of the present invention are preferably stored in nonvolatile memory such as Flash memory. Memory 418 also stores the necessary instructions and information for controller 406.

A microphone 414 is provided for converting voice from the user into electrical signals, while a speaker 416 provides audio signals to the user. A vocoder, Analog-to-Digital (A/D) and Digital-to-Analog (D/A) block 412 provides all the necessary digital voice processing for converting analog voice into digital data ready for RF transmission and vice versa. RF modulator/demodulator (transmitter/receiver) block 408 transmits and receives the RF signals via antenna 410.

In another embodiment of the invention, the radio user can select different smart replies for different users, and controller 406 can determine the identification number of the radio that transmitted a dispatch call and cause the selected smart reply to be sent to that radio. This is beneficial in certain situations, such as when a user wants to leave a particular smart reply to a particular person while another smart reply for other people (e.g., send “I will call you back after the meeting” to a specific user and “Out of the Office” to all other users).

By providing for either automatic or manual preprogrammed responses (smart replies) to dispatch calls, the present invention provides for a voice acknowledgement to the dispatch call if the recipient is busy or does not want to take the call. This helps the originator of the dispatch call know that the recipient heard him/her but cannot attend to the call, something that is currently missing in dispatch call environments.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method for providing a reply to a dispatch call transmitted by a first radio, comprising the steps of:
(a) receiving the dispatch call at a second radio; and
(b) transmitting a preprogrammed voice message by the second radio in response to step (a).

2. A method as defined in claim 1, wherein step (b) is performed automatically.

3. A method as defined in claim 1, wherein the voice message transmitted in step (b) is selected from amongst a plurality of voice messages stored in the second radio.

4. A method as defined in claim 3, wherein the second radio stores a record of the voice message that was transmitted.

5. A method as defined in claim 4, wherein the record of the voice message transmitted is stored in a recent calls list.

6. A method as defined in claim 1, wherein the user of the second radio manually selects the preprogrammed message that is transmitted in step (b).

7. A method as defined in claim 6, wherein the preprogrammed message is transmitted once the radio user activates a Push-To-Talk (PTT) switch located in the second radio.

8. A method as defined in claim 1, wherein the preprogrammed message transmitted in step (b) is a voice message that is recorded by the user of the second radio.

9. A method as defined in claim 1, wherein the voice message transmitted in step (b) is selected from amongst a plurality of voice messages stored in the second radio and the voice message transmitted in step (b) is automatically transmitted and selected given the identification number of the first radio.

10. A radio that can transmit and receive dispatch calls, comprising:
a receiver;
a transmitter coupled to the receiver;
a memory coupled to the receiver, stored within the memory is at least one preprogrammed voice message; and
responsive to a dispatch call being received at the receiver that was transmitted by a second radio, using the transmitter to transmit the at least one preprogrammed voice message to the second radio.

11. A radio as defined in claim 10, wherein the at least one preprogrammed voice message is automatically transmitted by the transmitter upon the dispatch call being received at the receiver.

12. A radio as defined in claim 10, wherein the at least one preprogrammed voice message is transmitted after the dispatch call has been received at the receiver and after it has been manually selected.

13. A radio as defined in claim 10, wherein the radio can receive both dispatch calls and cellular calls.

14. A radio as defined in claim 13, wherein the at least one preprogrammed message is recorded by the user of the radio.

15. A radio that can receive both half-duplex dispatch and full-duplex cellular calls, the radio comprising:
a memory, stored within the memory are a plurality of preprogrammed voice messages;
a transmitter;
a receiver coupled to the transmitter and memory; and
the transmitter automatically transmits one of the plurality of preprogrammed voice messages in response to the receiver receiving a dispatch call if an automatic reply mode has been selected.

16. A radio as defined in claim 15, wherein the radio user instead of selecting the automatic reply mode places the radio in a manual response mode which allows the radio user to select from amongst the plurality of preprogrammed voice messages the message the user wants to transmit in response to receiving the dispatch call.

17. A radio as defined in claim 16, wherein instead of having one of the plurality of preprogrammed voice messages being automatically transmitted in response to receiving the dispatch call the user of the radio inactivates the automatic reply mode and can respond to the dispatch call and begin communications with the radio that sent the dispatch call.

18. A radio as defined in claim 17, wherein the radio user manually selects one of the plurality of preprogrammed voice messages and transmit the manually selected message in response to receiving the dispatch call.

19. A radio as defined in claim 15, wherein the plurality of preprogrammed voice messages are programmed by the radio user.

20. A radio as defined in claim 15, wherein the plurality of preprogrammed voice message are labeled and are selected using a menu.
